(19) United States
(12) Patent Application Publication
(10) Pub. No.: US 2017/0259628 A1
(43) Pub. Date: Sep. 14, 2017

(54) INSTANT WIRELESS DETECTING APPARATUS

(71) Applicant: TA-MIN PENG, Taipei City (TW)

(72) Inventor: TA-MIN PENG, Taipei City (TW)

(21) Appl. No.: 15/069,941

(22) Filed: Mar. 14, 2016

(51) Int. Cl. B60C 23/04; B60C 23/00

(52) U.S. Cl. CPC B60C 23/0433; B60C 23/009

(57) ABSTRACT

An instant wireless detecting apparatus installed in a trailer which includes a detecting mechanism and a monitor. The detecting mechanism is provided for detecting a tire condition of each the plurality of tires on a bottom of a loading board. The detecting mechanism will generate an identification code corresponds to an identification code respectively and output a wireless signal to the monitor. The monitor is automatically matched with the detecting mechanism according to the identification code and the tire condition is to be determined according to the detecting signal of the detecting mechanism corresponding to the identification code. A prompted message is sent by the prompt component, such that the installation of tire pressure detecting component can be simplified and the time for the installation of the tire pressure detecting component cal also be reduced.

### FIELD OF THE INVENTION

The present invention relates to an instant wireless detecting apparatus, and in particular to an instant wireless detecting apparatus applied for a trailer.

### BACKGROUND OF THE INVENTION

According to the statistics show that the major accidents caused by the tire puncture which is accounted for 35% of all accidents. In addition, the tire puncture occurred while the driving speed is about 160 kilometers per hour or more, the mortality rate approaches 100%. Therefore, there are many countries which have also enforced the installation of tire pressure detectors on the cars, especially for the trailer with long body and heavy tonnage.

The trailer includes head of the tractor and the loading board is dragged by the head of the tractor. Because the trailer includes a plurality of tires, each the plurality of tire pressure detecting components is installed in each the plurality of tires on the bottom of the loading board and is installed in the monitor, and the setting of each the plurality of tire pressure detecting components in the plurality of tires and in the monitor is operated by manual so as to the monitor is matched with the signal of each the plurality of tire pressure detecting components, such that the signal of the tire pressure which is detected by the plurality of tire pressure detecting components is transmitted to the monitor. According to abovementioned, the installation for the plurality of tire pressure for the trailer is very complexity and waste time.

### SUMMARY OF THE INVENTION

An objective of the present invention is to provide instant wireless detecting apparatus, when the installation of the instant wireless apparatus is complete, the set of the instant wireless apparatus is automatically set up so as to the operation of the installation of the tire pressure detecting device is simplified and the installation time of the tire pressure detecting device can be reduced.

To realize the above objective, the present invention provides an instant wireless detecting apparatus which is installed in a trailer, the instant wireless detecting apparatus includes a detecting mechanism and a monitor. The detecting mechanism includes a plurality of detecting components and a wireless signal transceiver. The plurality of detecting components is installed in the plurality of tires on the bottom of a loading board of the trailer for detecting a tire condition of each the plurality of tires, in which the tire condition includes a tire pressure and tire temperature. The wireless signal transceiver is installed on the loading board of the trailer and the wireless signal transceiver is corresponding to each a plurality of identification codes and the plurality of identification codes is wirelessly matched with the plurality of detecting components respectively. The wireless signal transceiver is provided for receiving a plurality of detecting signals which is detected by the plurality of detecting components and a wireless signal which corresponds the plurality of identification codes is outputted by the wireless signal transceiver. The monitor includes a wireless signal receiver, a processor and prompt component. The wireless signal receiver is wirelessly connected with the wireless signal transceiver. The processor is electrically connected with the wireless signal transceiver for receiving the wireless signal and the processor is provided for determining the tire condition of each the plurality of tires corresponds each the plurality of identification codes and outputting a prompted message by the prompt component.

One embodiment of the present invention is to provide an instant wireless detecting apparatus, the detecting mechanism is constructed by a plurality of detecting mechanisms and the plurality of detecting mechanism is respectively installed on a plurality of loading boards of the trailer.

One embodiment of the present invention is to provide an instant wireless detecting apparatus, the prompt component includes a display component which is electrically connected the processor and the processor is provided for sending a display prompted message.

One embodiment of the present invention is to provide an instant wireless detecting apparatus, the prompt component includes a sound prompted component which is electrically connected the processor and the processor is provided for sending a sound prompted message.

One embodiment of the present invention is to provide an instant wireless detecting apparatus, the plurality of detecting components includes a power detecting component, and the power detecting component is provided for detecting the power of a battery of the detecting mechanism.

One embodiment of the present invention is to provide an instant wireless detecting apparatus, the processor is provided with a warning range, when a detecting signal is exceeded the warning range, the processor is provided for outputting a warning signal to the prompt component for alerting a warning message.

One embodiment of the present invention is to provide an instant wireless detecting apparatus, the detecting mechanism is a two-channel wireless temperature and pressure sensor.

One embodiment of the present invention is to provide an instant wireless detecting apparatus, the wireless signal transceiver includes a bluetooth transmission component and the wireless signal receiver includes a bluetooth receiving component.

The detecting mechanism and the monitor is paired automatically, and the wireless signal transceiver wirelessly transfers the tire condition of the plurality of tires of the trailer which is detected by the detecting component to the monitor so as to the installation of the tire pressure detecting device is simplified and the installation time of the tire pressure detecting device can also be reduced. In addition, another detecting mechanism can also install on another loading board of the trailer. The detecting mechanism is matched with the original monitor. When the loading board is dragged by the head of the tractor, the detecting mechanism is installed on the loading board which is automatically matched with the original monitor, such that the detection of the tire pressure of the trailer is more convenient and the detection is quickly accomplished.

### BRIEF DESCRIPTION OF THE DRAWINGS

The present invention will be apparent to those skilled in the art by reading the following description of a preferred embodiment thereof with reference to the drawings, in which:

FIG. 1 is a view showing an instant wireless detecting apparatus in accordance with the present invention;

FIG. 2 is a block diagram of showing an instant wireless detecting apparatus in accordance with the present invention;

FIG. 3 is a view of showing a two-channel wireless temperature and pressure sensor in accordance with the conventional prior art; and

FIG. 4 is a block diagram of showing an instant wireless detecting apparatus of another embodiment in accordance with the present invention.

### DETAILED DESCRIPTION OF THE PREFERRED EMBODIMENT

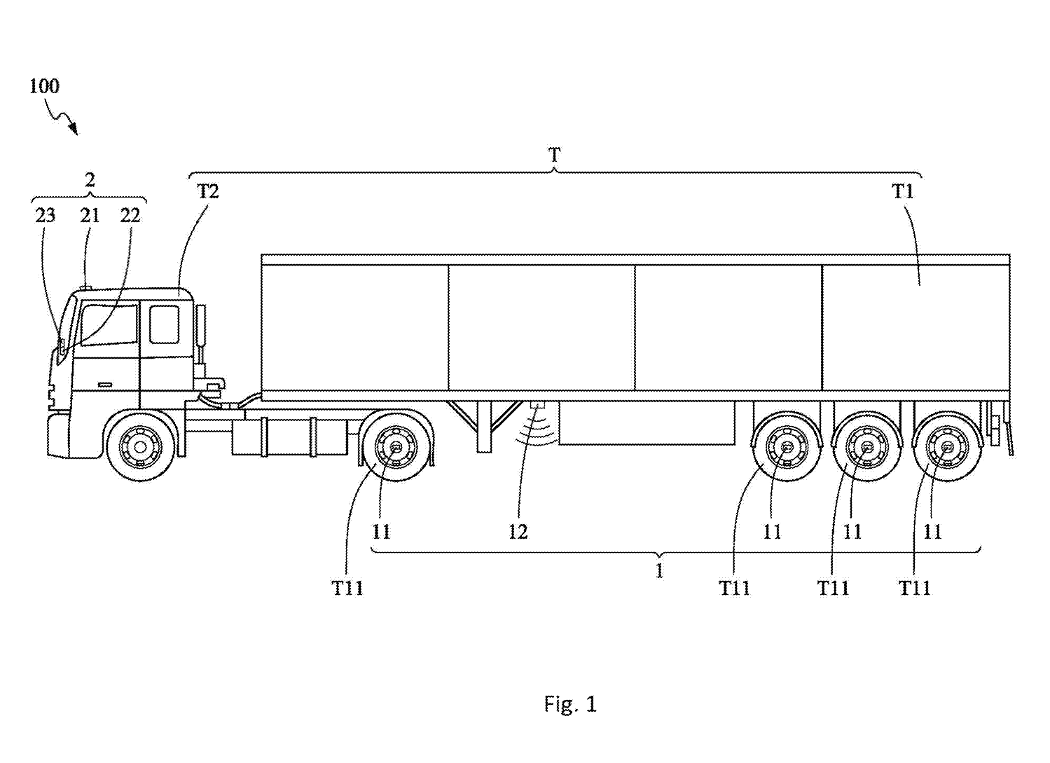

With reference to the drawings and in particular to FIG. 1 to FIG. 4, an instant wireless detecting apparatus is shown.

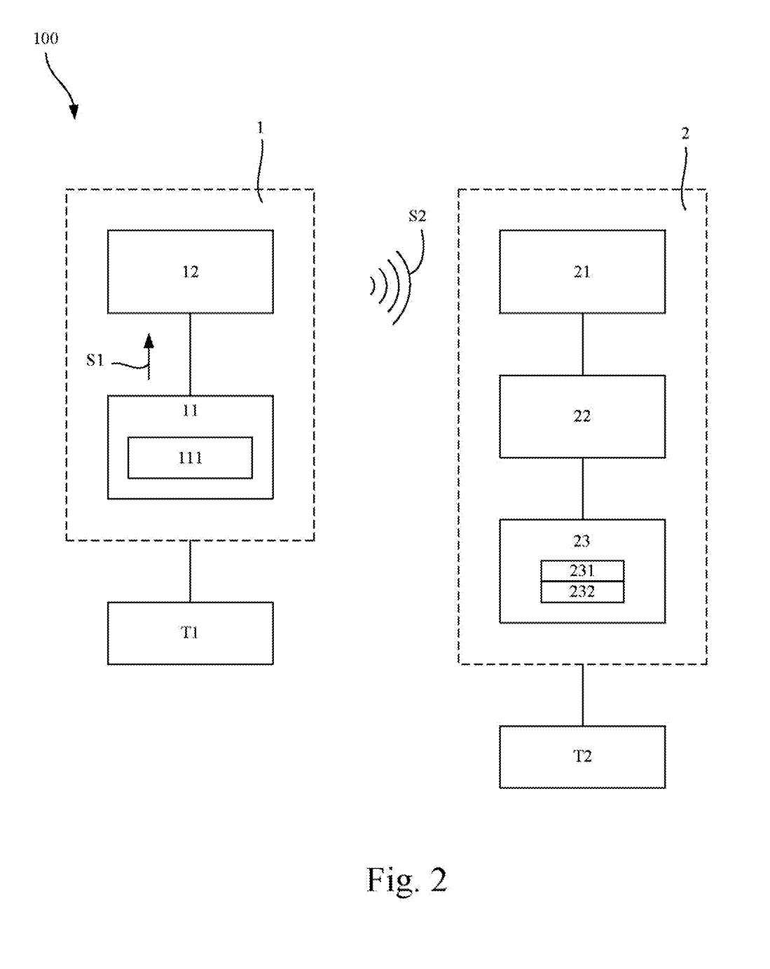

As shown in FIG. 1 and FIG. 2, an instant wireless detecting apparatus 100 of one embodiment of the present invention is installed in the trailer T, and the instant wireless detecting apparatus 100 includes a detecting mechanism 1 and a monitor 2.

The detecting mechanism 1 includes a plurality of detecting components 11 and a wireless signal transceiver 12. The plurality of detecting component 11 is installed in the plurality of tires T11 of a loading board T1 of the trailer T for detecting a tire condition of each the plurality of tires T11. That is, each the plurality of detecting components 11 is installed in each the plurality of tires T11 respectively. The tire condition for the plurality of tires T11 include a tire pressure within each the plurality of tires T11 and a tire temperature. The wireless signal transceiver 12 on the loading board T1 of the trailer T corresponds to each the plurality of identification codes respectively that is wirelessly matched with the plurality of detecting components 11. The wireless signal transceiver 12 receives the plurality of detecting signals S1 that is detected by the plurality of detecting components 11 and the wireless signal transceiver 12 outputs a wireless signal S2 according to the plurality of detecting signals S1 corresponds the plurality of identification codes. Specifically, each the plurality of detecting components 11 will generate a unique identification code. Preferably, the identification code is 32-bit code. Each the plurality of detecting component 11 is respectively installed in each the plurality of tires T11 for determining the tire condition of each the plurality of tires T1 of the loading board T1 by the identification code.

The monitor 2 includes a wireless signal receiver 21, a processor 22 and a prompt component 23. The wireless signal receiver 21 is wireless connected with the wireless signal transceiver 12. The processor 22 is electrically connected with the wireless matching signal receiver for receiving the wireless signal S2. The processor 22 is automatically matched with the detecting mechanism 1 according to the identification code, and based on the plurality of detecting signal S1 corresponds to the plurality of identification codes, the tire condition of each the plurality of tires T11 is determined based on the position of each of the plurality of detecting components 11. Then, a prompted message is outputted by the prompt component 23. Specifically, the prompt component 23 is electrically connected with the processor 22.

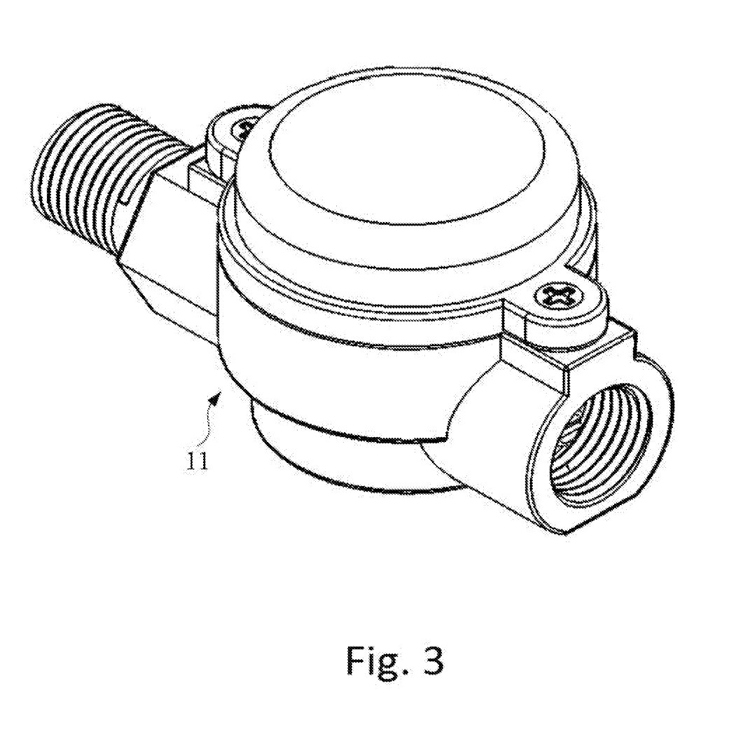

Preferably, as shown in FIG. 3, the detecting components 11 utilizes a two-channel wireless temperature and pressure sensor as shown in U.S. Publication No. US2015/0217606 A1. The tire condition includes a tire temperature. The wireless signal transceiver 12 includes a bluetooth transmission component and the wireless signal receiver 21 includes a bluetooth receiving component, in which the wireless signal is a bluetooth signal. Preferably, the wireless signal transceiver 12 is connected with the smart phone, a tablet, a laptop or other electronic component equipped with the bluetooth transmission module by bluetooth transmission component for data transmission.

As shown in FIG. 1 and FIG. 2, according to an instant wireless detecting apparatus 200 of the present invention, each the plurality of detecting components 11 includes a power detecting component 111 for detecting a power of a battery (not shown) of each the plurality of detecting components 11. The plurality of detecting signals S1 of the power of the battery of each the plurality of detecting components 11 is outputted as a wireless signal S2 by the wireless signal transceiver 12. Preferably, the battery of each the plurality of detecting components 11 is replaceable. More preferably, the battery of each the plurality of detecting components 11 can be replaced at the time of each the plurality of detecting components 11 is installed in each the plurality of tires T11.

As shown in FIG. 2, according to an instant wireless detecting apparatus 100 of the present invention, the prompter 23 includes a display component 231 which is electrically connected with the processor 22. The processor outputs a display prompted message through the display component 231. Preferably, the display prompted message includes a tire temperature, a tire pressure, the wireless signal strength and/or the power of the battery of the plurality of detecting components 11. The unit of tire temperature and/or tire pressure can be switched. Alternatively, the display component 231 includes a colorful backlight display for adjusting the color of the backlight. As shown in FIG. 2, according to an instant wireless detecting apparatus 100 of the present invention, the prompt component 23 includes a sound prompted component 232 that is electrically connected with the processor 22. The processor 22 outputs a sound prompted message through the sound prompted component 232. Of course, it is not to be limited in the present invention. The prompt component 23 may also include only a display component 231 or a sound prompted component 232. Alternatively, the prompt component 23 also includes a vibrating alert component (not shown). The vibrating alert component is electrically connected with the processor 22 and the processor 22 outputs a vibrating alert message through the vibrating alert component.

Preferably, the processor 22 is provided with a warning range, when the detecting signal S1 is exceeded the warning range, the processor 22 outputs an alarm signal to the prompt component 23 for warning. Preferably, the warning range is adjustable and the warning range can be adjusted according to the loading of the trailer and the ambient temperature. For example, when the tire condition of each the plurality of tires T11 is normal, that is, the plurality of detecting signals S1 is not exceeded the warning range so as to the display prompted component shows the tire condition in the normal way and the sound prompted component can alert a warning sound at a set time (for example, a half-hour). When the tire condition is in abnormal condition, the detecting signal S1 is exceeded the warning range, the display prompted component shows the flashing display for the tire condition and the sound prompted component alerts a warning sound at a set time (for example, one minute). Of course, it is not limited in the present invention. The prompt component 23 can alert otherwise prompted message or warning message.

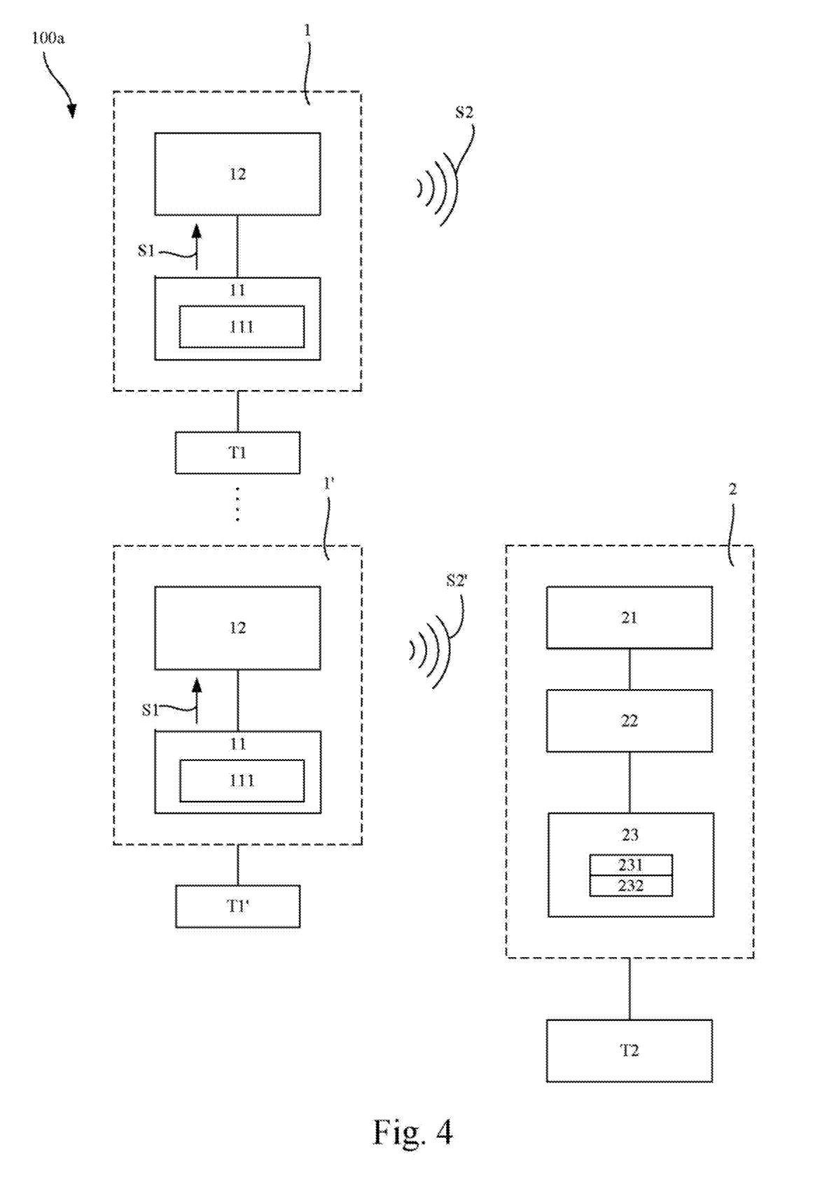

As shown in FIG. 4, according to the instant wireless detecting apparatus 100a of another embodiment of the present invention, the instant wireless detecting apparatus 100a includes a plurality of detecting mechanisms 1, 1a which is mounted on a plurality of loading boards T1, T1′ respectively. Specifically, each the plurality of wireless signal transceivers 12 is provided with a signal transmission range respectively. Each the plurality of detecting mechanisms 1. 1a merely receives the wireless signal S2′ which is sent from the wireless signal transceiver 12 on the loading board T1′ that is dragged by the head of the trailer T2. In addition, when the loading board T1 is replaced with another loading board T1′, the plurality of detecting mechanisms 1, 1a is matched with the monitor 2 automatically, such that the detection of the tire pressure of the trailer is more convenient and the detection is quickly accomplished.

Although the present invention has been described with reference to the preferred embodiment thereof, it is apparent to those skilled in the art that a variety of modifications and changes may be made without departing from the scope of the present invention which is intended to be defined by the appended claims. what is claimed is:

1. An instant wireless detecting apparatus installed in a trailer, the instant wireless detecting apparatus comprising:
a detecting mechanism, the detecting mechanism includes a plurality of detecting components and a wireless signal transceiver, the plurality of detecting components is installed in a plurality of tires on a bottom of a plurality of loading boards of the trailer for detecting a tire condition of each the plurality of tires, wherein the tire condition includes a tire pressure and/or a tire temperature, the wireless signal transceiver is installed on the plurality of loading boards of the trailer which is corresponding to each a plurality of identification codes and the plurality of identification codes is wirelessly matched with the plurality of detecting components respectively, the wireless signal transceiver is provided for receiving a plurality of detecting signals that is detected by the plurality of detecting components and a wireless signal corresponds to the plurality of identification codes and is outputted by the wireless signal transceiver; and
a monitor, the monitor includes a wireless signal receiver, a processor, and a prompt component, the wireless signal receiver is wirelessly connected with the wireless signal transceiver, the processor is electrically connected with the wireless signal transceiver for receiving the wireless signal, and the processor is provided for determining the tire condition of each the plurality of tires corresponding to each the plurality of identification codes and outputting an alerting message by the prompt component.

2. The instant wireless detecting apparatus according to claim 1, wherein the detecting mechanism is constructed by a plurality of detecting mechanisms and the plurality of detecting mechanisms is mounted on the plurality of loading boards of the respectively.

3. The instant wireless detecting apparatus according to claim 1, wherein the prompt component includes a display component which is electrically connected the processor and the processor is provided for outputting a display prompted message.

4. The instant wireless detecting apparatus according to claim 1, wherein the prompt component includes a sound prompted component which is electrically connected the processor, and the processor is provided for outputting a sound prompted message.

5. The instant wireless detecting apparatus according to claim 1, wherein the plurality of detecting components include a power detecting component and the power detecting component is provided for detecting the power of a battery of the detecting mechanism.

6. The instant wireless detecting apparatus according to claim 1, wherein the processor is provided with a warning range, when a detecting signal is exceeded the warning range, the processor is provided for outputting a warning signal to the prompt component for sending a warning message.

7. The instant wireless detecting apparatus according to claim 1, wherein the detecting mechanism is a two-channel wireless temperature and pressure sensor.

8. The instant wireless detecting apparatus according to claim 1, wherein the wireless signal transceiver includes a bluetooth transmission component, and the wireless signal receiver includes a bluetooth receiving component.
